(19) United States
(12) Patent Application Publication
(10) Pub. No.: US 2024/0375553 A1
(43) Pub. Date: Nov. 14, 2024

(54) SEAT CONTROL APPARATUS AND METHOD

(71) Applicants: HYUNDAI MOTOR COMPANY, Seoul (KR); KIA CORPORATION, Seoul (KR)

(72) Inventors: Kug Hun Han, Seoul (KR); Mun Seung Kang, Suwon-si (KR); Yo Han Kim, Ansan-si (KR); Dong Hoon Lee, Hwaseong-si (KR)

(73) Assignees: HYUNDAI MOTOR COMPANY, Seoul (KR); KIA CORPORATION, Seoul (KR)

(21) Appl. No.: 18/516,497

(22) Filed: Nov. 21, 2023

(30) Foreign Application Priority Data
May 14, 2023 (KR) 10-2023-0062089
Aug. 24, 2023 (KR) 10-2023-0111405

(51) Int. Cl. B60N 2/02; B60N 2/12

(52) U.S. Cl. CPC B60N 2/0268; B60N 2/02246; B60N 2/0228; B60N 2/12

(57) ABSTRACT

A seat control apparatus may receive a switch input from a user, through an input part. The seat control apparatus may also identify the side location of the seat by the first driving part and a reclining angle of the seat by the second driving part. The seat control apparatus may also identify a specific target state based on at least one of a type of a switch corresponding to the switch input, a corresponding function, a location section including the slide location, an angle section including the reclining angle, or any combination thereof. The seat control apparatus may also control a location of the seat such that the location of the seat corresponds to the specific target state by using at least one of the first driving part, the second driving part, or any combination thereof.

### CROSS-REFERENCE TO RELATED APPLICATION

This application claims the benefit of and priority to Korean Patent Application No. 10-2023-0062089, filed in the Korean Intellectual Property Office on May 14, 2023, and to Korean Patent Application No. 10-2023-0111405, filed in the Korean Intellectual Property Office on Aug. 24, 2023, the entire contents of which are incorporated herein by reference.

### TECHNICAL FIELD

The present disclosure relates to a seat control apparatus and a seat control method, and more particularly, to a technology for controlling a location of a seat based on a received switch input.

### BACKGROUND

With the development of technologies, various components may be operatively connected to each other in an interior of a vehicle. In particular, a seat control apparatus may perform a cooperative control of components for convenience of a user to promptly and accurately provide various functions.

For example, a vehicle may include a seat control apparatus that controls locations of a plurality of seats. The seat control apparatus may control a location of a seat by adjusting at least one of a backrest angle (or a reclining angle), a cushion height, a tilting angle (or an angle of a tip end of a seat cushion), a leg rest angle, a slide location, or any combination thereof to control the location (or an operation mode) of the seat.

In particular, with the development of these technologies, a seat control apparatus may perform a control of a location of a seat based on a fully automatic scheme by using at least one motor. For example, the seat control apparatus may adjust an angle of a backrest of a seat by using a recliner that is disposed in one area of the seat and includes at least one motor. Similarly, the seat control apparatus may adjust at least one of a backrest angle, a cushion height, a tilting angle, a leg rest angle, a slide location of the seat, or any combination thereof by using at least one driving part including at least one motor.

Meanwhile, at least one switch that receives an input by a user may be necessary to implement a control of a location of a seat by a fully automatic scheme. However, there is a limitation in minimizing the number of switches due to lack of mounting spaces and limitations in a space of the seat.

Accordingly, technical solutions have been being developed to minimize the number of switches by mounting an automatic switch (or a one touch button), to control a location of a seat to an operation state corresponding to the automatic switch when a user input to the automatic switch is received, and to implement the switch such that the seat is restored to an original state when a user input is received again.

However, in a control of a location of a seat in a fully automatic scheme, when the location control is stopped due to several situations while the seat is shifted to an operation state corresponding to an automatic switch or a user requires any one operation state between the corresponding operation state and a restoring state, it is difficult to perform the location control properly.

### SUMMARY

The present disclosure has been made to solve the above-mentioned problems occurring in the prior art while advantages achieved by the prior art are maintained intact.

An aspect of the present disclosure provides a seat control apparatus that, when receiving a user input through an input part, identifies a current location state of a seat, which includes a slide location of the seat by a first driving part and a reclining angle of the seat by a second driving part. The seat control apparatus also classifies the identified current location state for sections to perform different seat controls for the sections.

An aspect of the present disclosure also provides a seat control apparatus that identifies a specific target state based on at least one of a type of a switch corresponding to a switch input, a corresponding function, a location section including a slide location, or an angle section including a reclining angle, or any combination thereof. The seat control apparatus also controls a location of a seat such that the location of the seat corresponds to the specific target state by using at least one of a first driving part, a second driving part, or any combination thereof.

An aspect of the present disclosure provides a seat control apparatus including at least one automatic switch corresponding to a first control function of controlling an operation state of a seat to at least one of a tip and slide mode, a walk-in mode, an easy entry mode, a slide and go mode, a backrest folding mode, a double folding mode, a stand-up mode, a dive and go mode, a relaxation mode, or any combination thereof. Alternatively, the first control function includes restoring the operation state of the seat to an original state. The seat control apparatus also includes at least one manual switch corresponding to a second control function of adjusting at least one of a slide location, a cushion height, a tilting angle, a backrest angle, a leg rest angle, or any combination thereof in correspondence to a specific input received from the user.

An aspect of the present disclosure also provides a seat control apparatus that, when it is identified that the seat control apparatus is operated again or a host vehicle is restarted, or no passenger is seated on the seat, identifies the slide location of the seat and the reclining angle of the seat. When the slide location is included in the first angle section or the reclining angle is included in the first angle section, the seat control apparatus identifies whether an automatic movement setting for the seat is an on state. When the automatic movement setting is in an on state, the seat control apparatus controls the seat to a defined target location based on the automatic movement setting.

An aspect of the present disclosure provides a seat control apparatus that identifies in which of a first location section and a second location section disposed at a rear location section of the first location section a slide location of a seat is included, by using the sensor part, and identifies in which of a first angle section and a second angle section disposed at a rear angle section of the first angle section a reclining angle of the seat is included.

The technical problems to be solved by the present disclosure are not limited to the aforementioned problems. Any other technical problems not mentioned herein should be more clearly understood from the following description by those having ordinary skill in the art to which the present disclosure pertains.

According to an aspect of the present disclosure, a seat control apparatus includes an input part disposed in one area of a seat, a first driving part that adjusts a slide location of the seat, and a second driving part that adjusts a reclining angle of the seat. The seat control apparatus also includes a memory that stores one or more instructions and a controller operatively connected to the input part, the first driving part, the second driving part, and the memory. The instructions, when being executed by the controller, cause the seat control apparatus to receive a switch input from a user, through the input part. The seat control apparatus is also caused to identify the slide location of the seat by the first driving part and a reclining angle of the seat by the second driving part. The seat control apparatus is also caused to identify a specific target state based on at least one of a type of a switch corresponding to the switch input, a corresponding function, a location section including the slide location, an angle section including the reclining angle, or any combination thereof. The seat control apparatus is also caused to control a location of the seat such that the location of the seat corresponds to the specific target state by using at least one of the first driving part, the second driving part, or any combination thereof.

According to an embodiment, types of the switch may include at least one automatic switch corresponding to a first control function of controlling an operation state of the seat to at least one of a tip and slide mode, a walk-in mode, an easy entry mode, a slide and go mode, a backrest folding mode, a double folding mode, a stand-up mode, a dive and go mode, a relaxation mode, or any combination thereof. Alternatively, the first control function may include restoring the operation state of the seat to an original state. Types of the switch may include at least one manual switch corresponding to a second control function of adjusting at least one of a slide location, a cushion height, a tilting angle, a backrest angle, a leg rest angle, or any combination thereof in correspondence to a specific input received from the user.

According to an embodiment, the instructions, when being executed by the controller, may cause the seat control apparatus to identify the specific target state based on a corresponding function of the first control function. The first control function may correspond to at least one automatic switch when the switch input is received through a corresponding automatic switch. The seat control apparatus may be also caused to control a location of the seat based on the identified specific target state.

According to an embodiment, the instructions, when being executed by the controller, may cause to the seat control apparatus to identify a type of the switch corresponding to the switch input when the slide location is included in a first location section. The seat control apparatus may be also caused to perform a predefined automatic control function in correspondence to the switch input when the type of the switch corresponds to the at least one manual switch.

According to an embodiment, the instructions, when being executed by the controller, may cause the seat control apparatus to identify the specific target state based on the corresponding function of the first control function and the second control function. The second control function may correspond to an input type of the switch input and the at least one automatic switch when the slide location is included in a second location section disposed at a rear location section of the first location section, or when the slide location is included in the first location section and the type of the switch corresponds to the at least one automatic switch. The seat control apparatus may be also caused to control the location of the seat based on the identified specific target state.

According to an embodiment, the instructions, when being executed by the controller, may cause to the seat control apparatus to identify a type of the switch corresponding to the switch input when the reclining angle is included in a first angle section. The seat control apparatus may be also caused to perform a predefined automatic control function in correspondence to the switch input when the type of the switch corresponds to the at least one manual switch.

According to an embodiment, the instructions, when being executed by the controller, may cause to the seat control apparatus to identify the specific target state based on the corresponding function of the first control function and the second control function. The second control function may correspond to an input type of the switch input and the at least one automatic switch when the reclining angle is included in a second angle section disposed at a rear angle section of the first angle section, or when the reclining angle is included in the first angle section and the type of the switch corresponds to the at least one automatic switch. The seat control apparatus may be also caused to control the location of the seat based on the identified specific target state.

According to an embodiment, the instructions, when being executed by the controller, may cause to the seat control apparatus to identify a type of the switch corresponding to the switch input when the slide location is included in a first location section or the reclining angle is included in a first angle section. The seat control apparatus may be also caused to identify the specific target state based on the corresponding function of the first control function. The first control function may correspond to the at least one automatic switch and control the location of the seat based on the identified specific target state when the type of the switch corresponds to the at least one automatic switch. The seat control apparatus may be also caused to perform a predefined automatic control function in correspondence to the switch input when the type of the switch corresponds to the at least one manual switch.

According to an embodiment, the instructions, when being executed by the controller, may cause to the seat control apparatus to identify the slide location of the seat and the reclining angle of the seat when it is identified that the seat control apparatus is operated again, a host vehicle is restarted, or no passenger is seated on the seat. The seat control apparatus may be also caused to identify whether an automatic movement setting for the seat is an on state when the slide location is included in a first location section or the reclining angle is included in a first angle section. The seat control apparatus may be also caused to control the seat to a target location defined based on the automatic movement setting when the automatic movement setting is in the on state.

According to an embodiment, the seat control apparatus may further include a sensor part. The instructions, when being executed by the controller, may cause to the seat control apparatus to identify in which of a first location section and a second location section disposed at a rear location section of the first location section the slide location of the seat is included, by using the sensor part. The seat control apparatus may be also caused to identify in which of a first angle section and a second angle section disposed at a rear angle section of the first angle section the reclining angle of the seat is included, by using the sensor part.

According to another aspect of the present disclosure, a seat control method includes receiving, by a controller, a switch input from a user through an input part. The seat control method also includes identifying, by the controller, a slide location of a seat by a first driving part and a reclining angle of the seat by a second driving part. The seat control method also includes identifying, by the controller, a specific target state based on at least one of a type of a switch corresponding to the switch input, a corresponding function, a location section including a type of the slide location, an angle section including the reclining angle, or any combination thereof. The seat control method also includes controlling, by the controller, a location of the seat such that the location of the seat corresponds to the specific target state by using at least one of the first driving part, the second driving part, or any combination thereof.

According to an embodiment, types of the switch may include at least one automatic switch corresponding to a first control function of controlling an operation state of the seat to at least one of a tip and slide mode, a walk-in mode, an easy entry mode, a slide and go mode, a backrest folding mode, a double folding mode, a stand-up mode, a dive and go mode, or a relaxation mode, or any combination thereof. Alternatively, the first control function may include restoring the operation state of the seat to an original state. Types of the switch may include at least one manual switch corresponding to a second control function of adjusting at least one of a slide location, a cushion height, a tilting angle, a backrest angle, a leg rest angle, or any combination thereof in correspondence to a specific input received from the user.

According to an embodiment, the receiving, by a controller, of the switch input from the user, through the input part may include identifying, by the controller, the specific target state based on, a corresponding function of the first control function. The first control function may correspond to at least one automatic switch when the switch input is received through a corresponding one automatic switch. The receiving, by the controller, of the switch input from the user, through the input part may include controlling, by the controller, a location of the seat based on the identified specific target state.

According to an embodiment, the seat control method may include identifying, by the controller, a type of the switch corresponding to the switch input when the slide location is included in a first location section. The seat control method may also include performing, by the controller, a predefined automatic control function in correspondence to the switch input when the type of the switch corresponds to the at least one manual switch.

According to an embodiment, the seat control method may further include identifying, by the controller, the specific target state based on the corresponding function of the first control function and the second control function. The second control function may correspond to an input type of the switch input and the at least one automatic switch when the slide location is included in a second location section disposed at a rear location section of the first location section, or when the slide location is included in the first location section and the type of the switch corresponds to the at least one automatic switch. The seat control method may also include controlling, by the controller, the location of the seat based on the identified specific target state.

According to an embodiment, the seat control method may further include identifying, by the controller, a type of the switch corresponding to the switch input when the slide location is included in a first location section. The seat control method may also include performing, by the controller, a predefined automatic control function in correspondence to the switch input when the type of the switch corresponds to the at least one manual switch.

According to an embodiment, the seat control method may further include identifying, by the controller, the specific target state based on the corresponding function of the first control function and the second control function. The second control function may correspond to an input type of the switch input and the at least one automatic switch when the slide location is included in a second location section disposed at a rear location section of the first location section, or when the slide location is included in the first location section and the type of the switch corresponds to the at least one automatic switch. The seat control method may also include controlling, by the controller, the location of the seat based on the identified specific target state.

According to an embodiment, the seat control method may further include identifying, by the controller, a type of the switch corresponding to the switch input when the slide location is included in a first location section or the reclining angle is included in the first angle section. The seat control method may also include identifying, by the controller, the specific target state based on the corresponding function of the first control function. The first control function may correspond to the at least one automatic switch and control the location of the seat based on the identified specific target state when the type of the switch corresponds to the at least one automatic switch. The seat control method may also include performing, by the controller, a predefined automatic control function in correspondence to the switch input when the type of the switch corresponds to the at least one manual switch.

According to an embodiment, the seat control method may include identifying, by the controller, the slide location of the seat and the reclining angle of the seat when it is identified that the seat control apparatus is operated again, a host vehicle is restarted, or no passenger is seated on the seat. The seat control method may also include identifying, by the controller, whether an automatic movement setting for the seat is an on state when the slide location is included in a first location section or the reclining angle is included in a first angle section. The seat control method may also include controlling, by the controller, the seat to a target location defined based on the automatic movement setting when the automatic movement setting is in the on state.

According to an embodiment, the seat control method may further include identifying, by the controller, in which of a first location section and a second location section disposed at a rear location section of the first location section the slide location of the seat is included, by using a sensor part. The seat control method may further include identifying, by the controller, in which of a first angle section and a second angle section disposed at a rear angle section of the first angle section the reclining angle of the seat is included, by using the sensor part.

### BRIEF DESCRIPTION OF THE DRAWINGS

The above and other objects, features, and advantages of the present disclosure should be more apparent from the following detailed description taken in conjunction with the accompanying drawings:

FIG. 1 is a block diagram illustrating components of a seat control apparatus according to an embodiment of the present disclosure;

FIG. 2A is a conceptual view illustrating an operation state of a seat through control of a seat control apparatus according to an embodiment of the present disclosure;

FIG. 2B is a conceptual view illustrating an operation state of a seat through control of a seat control apparatus according to an embodiment of the present disclosure;

FIG. 2C is a conceptual view illustrating an operation state of a seat through control of a seat control apparatus according to an embodiment of the present disclosure;

FIG. 2D is a conceptual view illustrating an operation state of a seat through control of a seat control apparatus according to an embodiment of the present disclosure;

FIG. 2E is a conceptual view illustrating an operation state of a seat through control of a seat control apparatus according to an embodiment of the present disclosure;

FIG. 3A is a conceptual view illustrating an input part of a seat control apparatus according to an embodiment of the present disclosure;

FIG. 3B is a conceptual view illustrating an input part of a seat control apparatus according to an embodiment of the present disclosure;

FIG. 4 is a block diagram illustrating components of a seat control apparatus according to an embodiment of the present disclosure;

FIG. 5A is a conceptual view illustrating a classification of an angle section including a reclining angle of a seat according to an embodiment of the present disclosure;

FIG. 5B is a conceptual view illustrating a classification of an angle section in which a reclining angle of a seat is included, according to an embodiment of the present disclosure;

FIG. 6A is a conceptual view illustrating a classification of a location section in which a slide location of a seat is included, according to an embodiment of the present disclosure;

FIG. 6B is a conceptual view illustrating a classification of a location section in which a slide location of a seat is included, according to an embodiment of the present disclosure;

FIG. 7 is a flowchart of a seat control method according to an embodiment of the present disclosure;

FIG. 8 is a flowchart of a seat control method according to an embodiment of the present disclosure;

FIG. 9 is a flowchart of a seat control method according to an embodiment of the present disclosure;

FIG. 10 is a flowchart of a seat control method according to an embodiment of the present disclosure; and

FIG. 11 illustrates a computing system regarding a seat control method according to an embodiment of the present disclosure.

In relation to a description of the drawings, the same or similar components are denoted by the same or similar reference numerals.

### DETAILED DESCRIPTION

Hereinafter, embodiments of the present disclosure are described in detail with reference to the accompanying drawings. In adding reference numerals to the components of the drawings, it is noted that the same or equivalent components are denoted by the same reference numerals even when the components are drawn in different drawings. Furthermore, in describing the embodiments of the present disclosure, where it has been determined that a detailed description of related known configurations and functions may hinder understanding of the embodiments of the present disclosure, a detailed description thereof has been omitted.

Furthermore, in describing the components of the embodiments of the present disclosure. Terms, such as first, second, “A”, “B”, (a), and (b) may be used. The terms are simply for distinguishing the components, and the essence, the sequence, and the order of the corresponding components are not limited by the terms. Furthermore, unless otherwise defined, all terms, including technical and scientific terms, used herein have the same meaning as commonly understood by those having ordinary skill in the art to which the present disclosure pertains. It should be further understood that terms, such as those defined in commonly used dictionaries, should be interpreted as having meanings that are consistent with their meanings in the context of the present disclosure and the relevant art and should not be interpreted in an idealized or overly formal sense unless expressly so defined herein. When a component, device, element, or the like of the present disclosure is described as having a purpose or performing an operation, function, or the like, the component, device, element, or the like should be considered herein as being “configured to” meet that purpose or to perform that operation or function. Each component, device, element, and the like may separately embody or be included with a processor and a memory, such as a non-transitory computer readable media, as part of the apparatus.

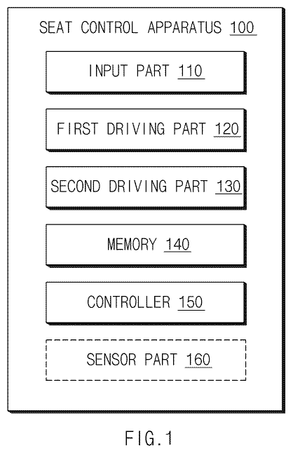

Hereinafter, embodiments of the present disclosure are described with reference to FIGS. 1-11.

FIG. 1 is a block diagram illustrating components of a seat control apparatus according to an embodiment of the present disclosure.

According to an embodiment, a seat control apparatus 100 may include at least one of an input part 110, a first driving part 120, a second driving part 130, a memory 140, a controller 150, a sensor part 160, or any combination thereof. A configuration of the seat control apparatus 100, which is illustrated in FIG. 1, is exemplary, and the embodiments of the present disclosure are not limited thereto. For example, the seat control apparatus 100 may further include components (e.g., at least one of a memory, an interface part, a communication part, a display part, or any combination thereof) that are not illustrated in FIG. 1.

According to an embodiment, the input part 110 may include at least one switch.

For example, the input part 110 may include at least one switch provided in one area of a seat. The one area, as an example, may include one area of a backrest of the seat and/or one area of a side cushion of the seat.

For example, the input part 110 may include a plurality of switches corresponding to at least one type. As an example, the input part 110 may include a plurality of switches of types that are distinguished from each other.

As an example, the types of the switch may include an automatic switch and/or a manual switch.

The automatic switch, for example, may include at least one switch corresponding to a first control function of controlling an operation state of the seat to at least one of a tip and slide mode, a walk-in mode, an easy entry mode, a slide and go mode, a backrest folding mode, a double folding mode, a stand-up mode, a dive and go mode, a relaxation mode, or any combination thereof. Alternatively, the first control function includes restoring the operation state of the seat to an original state. When a switch input (e.g., a touch input by a user) to the automatic switch is detected, the seat control apparatus 100 may perform the first control function.

The manual switch may include at least one switch corresponding to a second control function of adjusting at least one of a slide location, a cushion height, a tilting angle, a backrest angle, a leg rest angle, or any combination thereof, of the seat in correspondence to a specific input received from the user. When a switch input (e.g., a touch input by the user) to the manual switch is detected, the seat control apparatus 100 may perform the second control function.

According to an embodiment, the first driving part 120 may include at least one driving device that controls a slide location of the seat.

For example, the first driving part 120 may include at least one motor that controls the slide location of the seat to a front side and a rear side.

According to an embodiment, the second driving part 130 may include at least one motor that controls a reclining angle of the seat.

For example, the second driving part 130 may include at least one of at least one motor that controls the reclining angle of the seat to a specific angle, a recliner, or any combination thereof.

According to an embodiment, the memory 140 may store instructions or data. For example, the memory 140 may store one or more instructions that, when being executed by the controller 150, cause the seat control apparatus 100 to perform various operations.

For example, the memory 140 may be implemented with the controller 150 in one chip. The controller 150 may include at least one of a communication processor or a modem.

According to an embodiment, the controller 150 may be operatively connected to at least one of the input part 110, the first driving part 120, the second driving part 130, the memory 140, the sensor part 160, or any combination thereof. For example, the controller 150 may control an operation of at least one of the input part 110, the first driving part 120, the second driving part 130, the memory 140, the sensor part 160, or any combination thereof.

For example, the controller 150 may receive a switch input from the user, through the input part 110.

As an example, the controller 150 may receive a user input (e.g., a touch input by the user) to at least one of a plurality of input devices (e.g., switches) included in the input part 110, as a switch input.

As an example, when receiving the switch input, the controller 150 may identify at least one of the type of the switch corresponding to the switch input, a corresponding function, an input type (e.g., an input direction) of the switch input, or any combination thereof.

For example, the controller 150 may identify a slide location of the seat by the first driving part 120 and may identify a reclining angle of the seat by the second driving part 130.

As an example, the controller 150 may identify the slide location and the reclining angle of the seat by using operation states (e.g., at least one of an rpm, a current operation section, or a combination thereof) of the first driving part 120 and the second driving part 130.

As an example, the controller 150 may identify whether the slide location of the seat corresponds to which one of the first location section and the second location section. The second location section, for example, may be disposed at a rear location section of the first location section.

As an example, the controller 150 may identify whether the reclining angle of the seat corresponds to which one of the first angle section and the second angle section. The second angle section, for example, may be disposed at a rear angle section of the first angle section.

As an example, the controller 150 may identify whether the slide location of the seat is included in which one of a first location section and a second location section disposed at a rear location section of the first location section, by using the sensor part 160. The controller 150 may also identify whether the reclining angle is included in which one of a first angle section and a second angle section disposed at a rear angle section of the first angle section.

For example, the controller 150 may identify the specific target state based on at least one of the type of the switch corresponding to the switch input, the location section in which the slide location is included, the angle section in which the reclining angle is included, or any combination thereof.

As an example, when a switch input is received through at least one automatic switch, the controller 150 may identify the specific target state based on a corresponding function of the above-described first control function, which corresponds to the automatic switch. The controller 150, for example, may control a location of the seat based on the identified specific target state.

As an example, when the slide location is included in the first location section, the controller 150 may identify the type of the switch corresponding to the switch input. When the type of the switch corresponds to the at least one manual switch, the controller 150 may perform a predefined automatic control function corresponding to the switch input. The predefined automatic control function, for example, may include a control function of controlling the location of the seat to at least one of a non-operation mode (or a switch input neglected mode), an elevation mode, a folding mode, a restoring mode, a foremost mode, a rearmost mode, a manufacturer setting mode, a user storing mode, or any combination thereof.

As an example, when the slide location is included in a second location section disposed at a rear location section of the first location section, or when the slide location is included in the first location section and the type of the switch does not correspond to the at least one manual switch (e.g., the type of the switch corresponds to the at least one automatic switch), the controller 150 may identify the specific target state based on the corresponding function of the first control function and the second control function, which corresponds to the input type of the switch input and the at least one manual switch.

In other words, when a switch input is received in a state in which the slide location of the seat is included in the second location section, the controller 150 may identify the type of the switch corresponding to the switch input. For example, when type of the switch input is the automatic switch, the controller 150 may identify the specific target state based on a corresponding function of the first control function, which corresponds to the corresponding automatic switch to control the location of the seat. For example, when the type of the switch input is the manual switch, the controller 150 may control the location of the seat based on a corresponding function of the second control function, which corresponds to the type (e.g., at least one of a slide angle adjusting switch, a reclining angle adjusting switch, a cushion angle adjusting switch, a leg rest angle adjusting switch, or any combination thereof) and the input type (or the input direction) to the corresponding manual switch by the user.

Furthermore, when the slide location of the seat is included in the first location section and the switch corresponding to the switch input does not correspond to the manual switch (e.g., the type of the switch corresponds to the at least one automatic switch), the location of the seat may be controlled based on a corresponding function of the second control function, which corresponds to the type of the corresponding manual switch and the type of the input by the user to the corresponding manual switch.

As an example, when the reclining angle of the seat is included in the first angle section, the controller 150 may identify the type of the switch corresponding to the switch input. When the type of the switch corresponds to at least one manual switch, the controller 150 may perform a predefined automatic control function corresponding to the switch input. The predefined automatic control function, for example, may include a control function of controlling the location of the seat to at least one of a non-operation mode (or a switch input neglected mode), an elevation mode, a folding mode, a restoring mode, a foremost mode, a rearmost mode, a producer setting mode, a user storing mode, or any combination thereof.

As an example, when the reclining angle is included in a second angle section disposed at a rear angle section of the first angle section or when the reclining angle is included in the first angle section and the type of the switch corresponds to at least one automatic switch, the controller 150 may identify a specific target state based on a corresponding function of the first control function and the second control function, which corresponds to the input type of the switch input and at least one automatic switch.

In other words, when a switch input is received in a state in which the reclining angle of the seat is included in the second angle section, the controller 150 may identify the type of the switch corresponding to the switch input. For example, when the type of the switch corresponding to the switch input is the automatic switch, the controller 150 may identify the specific target state based on a corresponding function of the first control function, which corresponds to the corresponding automatic switch to control the location of the seat. For example, when the type of the switch input is the manual switch, the controller 150 may control the location of the seat based on a corresponding function of the second control function, which corresponds to the type of the corresponding manual switch and the type of the input by the user to the corresponding manual switch.

Furthermore, when the reclining angle of the seat is included in the first location section and the switch corresponding to the switch input corresponds to the manual switch, the controller 150 may control the location of the seat based on a corresponding function of the second control function, which corresponds to the type of the corresponding manual switch and the type of the input by the user to the corresponding manual switch.

As an example, when the slide location is included in the first angle section or the reclining angle is included in the first angle section, the controller 150 may identify the type of the switch corresponding to the switch input. When the type of the switch corresponds to at least one automatic switch, the controller 150 may identify the specific target state based on a corresponding function of the first control function, which corresponds to at least one automatic switch, and may control the location of the seat based on the specific target state. When the type of the switch corresponds to at least one manual switch, the controller 150 may perform a predefined automatic control function in correspondence to the switch input.

As an example, when it is identified that the seat control apparatus is operated again, a host vehicle is restarted, or a door corresponding to the seat is opened in a state in which no passenger is seated on the seat, the controller 150 may identify the slide location of the seat and the reclining angle of the seat. For example, when the slide location is included in the first angle section and the reclining angle is included in the first angle section, the controller 150 may identify whether an automatic movement setting for the seat is in an on state. When the automatic movement setting is in the on state, the controller 150 may control the seat to a defined target location based on the automatic movement setting.

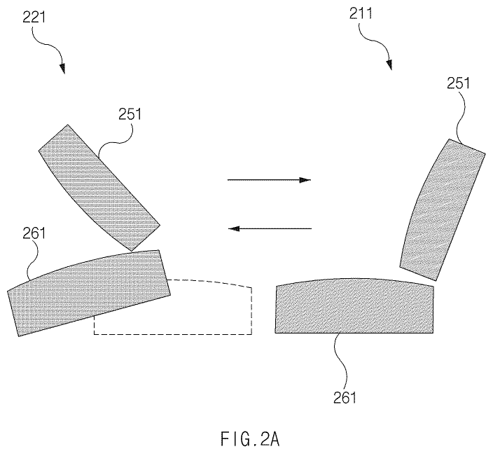

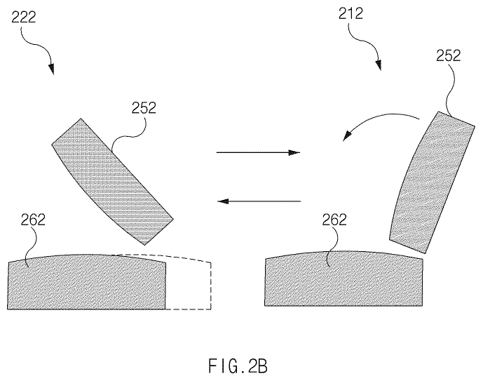

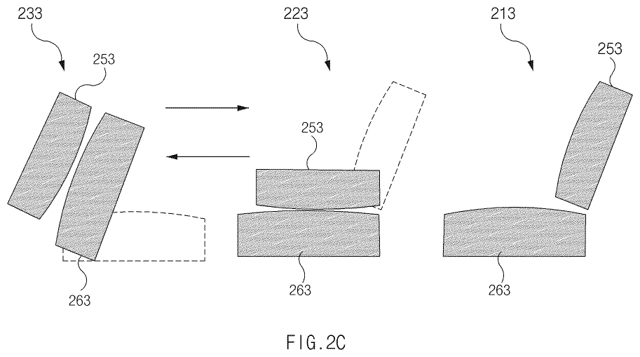

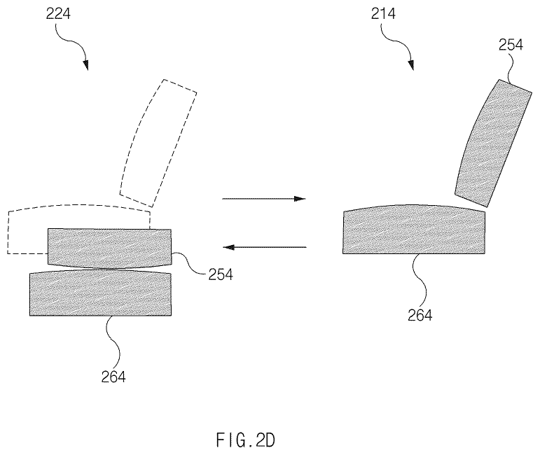

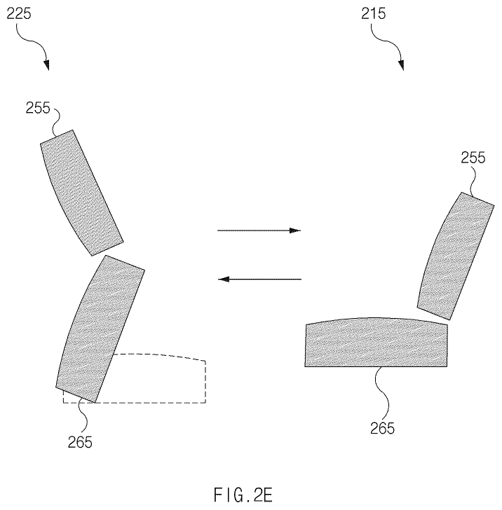

Hereinafter, a description of FIGS. 2A, 2B, 2C, 2D, and 2E may be a description of the embodiments regarding various operation states (or operation modes) that may be set based on a location control of the seat control apparatus (e.g., the seat control apparatus 100 of FIG. 1).

FIG. 2A is a conceptual view illustrating an operation state of the seat through control of the seat control apparatus according to an embodiment of the present disclosure.

According to an embodiment, the seat control apparatus (e.g., the seat control apparatus 100 of FIG. 1) may control locations (or angles) of a backrest 251 and a cushion 261 of the seat to a general mode or, a tip (or up) and slide mode.

Referring to reference numeral 211, according to an embodiment, the seat control apparatus may control the locations of the backrest 251 and the cushion 261 of the seat based on the general mode. The general mode, for example, may be defined as a seat location state in a general situation in which the user may be conveniently on board while the host vehicle is traveling.

Referring to reference numeral 221, according to an embodiment, when receiving a switch input (e.g., a pressure input by the user to an automatic switch corresponding to the tip and slide mode) corresponding to a request for an operation in the tip and slide mode while the location state of the seat is maintained based on the general mode, the seat control apparatus may control the seat to the location state according to reference numeral 221. For example, the seat control apparatus may move the backrest 251 to a front side and move the cushion 261 to a front side by adjusting an angle of the backrest 251 of the seat to control the operation mode of the seat to the tip and slide mode. Through the control of the location of the seat, the user may move to the rear seat of the seat illustrated in FIG. 2A conveniently and promptly.

FIG. 2B is a conceptual view illustrating an operation state of the seat through control of the seat control apparatus according to an embodiment of the present disclosure.

According to an embodiment, the seat control apparatus (e.g., the seat control apparatus 100 of FIG. 1) may control the locations of a backrest 252 and a cushion 262 of the seat to the general mode or the walk-in slide mode.

Referring to reference numeral 212, according to an embodiment, the seat control apparatus may control the locations of the backrest 252 and the cushion 262 of the seat based on the general mode. The general mode, for example, may be defined as a location state of the seat in a general situation in which the user may be conveniently on board while the host vehicle is traveling.

Referring to reference numeral 222, according to an embodiment, when receiving a switch input (e.g., a pressure input by the user to an automatic switch corresponding to the walk-in slide mode) corresponding to a request for an operation in the walk-in slide mode while the location state of the seat is maintained based on the general mode, the seat control apparatus may control the seat to the location state according to reference numeral 222. For example, the seat control apparatus may move the backrest 252 to a front side and move the cushion 262 to a front side by adjusting an angle of the backrest 252 of the seat to control the operation mode of the seat to the walk-in slide mode. Through the control of the location of the seat, the user may move to the rear seat of the seat illustrated in FIG. 2B conveniently and promptly.

FIG. 2C is a conceptual view illustrating an operation state of the seat through control of the seat control apparatus according to an embodiment of the present disclosure.

According to an embodiment, the seat control apparatus (e.g., the seat control apparatus 100 of FIG. 1) may control the locations of a backrest 253 and a cushion 263 of the seat to the general mode or the double folding mode.

Referring to reference numeral 213, according to an embodiment, the seat control apparatus may control the locations of the backrest 253 and the cushion 263 of the seat based on the general mode. The general mode, for example, may be defined as a location state of the seat in a general situation in which the user may be conveniently on board while the host vehicle is traveling.

Referring to reference numeral 223, according to an embodiment, when receiving a switch input (e.g., a pressure input by the user to an automatic switch corresponding to the double folding mode) corresponding to a request for an operation in the double folding mode while the location state of the seat is maintained based on the general mode, the seat control apparatus may control the seat to the location state according to reference numeral 223. For example, the seat control apparatus may move (or fold) the backrest 253 to a front side by adjusting an angle of the backrest 253 of the seat. Thereafter, the seat control apparatus may control the seat to a location state according to reference numeral 233.

Referring to reference numeral 233, according to an embodiment, when the backrest 253 has been folded by adjusting the angle of the backrest 253, the seat control apparatus raises an end of the cushion 263 to an upper side to control the operation mode of the seat to the double folding mode. Through the control of the location of the seat, the user may move to the rear seat of the seat illustrated in FIG. 2C conveniently and promptly.

FIG. 2D is a conceptual view illustrating an operation state of the seat through control of the seat control apparatus according to an embodiment of the present disclosure.

According to an embodiment, the seat control apparatus (e.g., the seat control apparatus 100 of FIG. 1) may control the locations (or angles) of a backrest 254 and a cushion 264 of the seat to the general mode or the dive and go mode.

Referring to reference numeral 214, according to an embodiment, the seat control apparatus may control the locations of the backrest 254 and the cushion 264 of the seat based on the general mode. The general mode, for example, may be defined as a location state of the seat in a general situation in which the user may be conveniently on board while the host vehicle is traveling.

Referring to reference numeral 224, according to an embodiment, when receiving a switch input (e.g., a pressure input by the user to an automatic switch corresponding to the dive and go mode) corresponding to a request for an operation in the dive and go mode while the location state of the seat is maintained based on the general mode, the seat control apparatus may control the seat to the location state according to reference numeral 224. For example, the seat control apparatus may move (or fold) the backrest 254 to a front side and move the cushion 264 to a lower side by adjusting an angle of the backrest 254 of the seat. Through the control of the seat location control, the user may move to the rear seat of the seat illustrated in FIG. 2D conveniently and promptly.

FIG. 2E is a conceptual view illustrating an operation state of the seat through control of the seat control apparatus according to an embodiment of the present disclosure.

According to an embodiment, the seat control apparatus (e.g., the seat control apparatus 100 of FIG. 1) may control the locations (or angles) of a backrest 255 and a cushion 265 of the seat to the general mode or the stand-up mode.

Referring to reference numeral 215, according to an embodiment, the seat control apparatus may control the locations of the backrest 255 and the cushion 265 of the seat based on the general mode. The general mode, for example, may be defined as a location state of the seat in a general situation in which the user may be conveniently on board while the host vehicle is traveling.

Referring to reference numeral 225, according to an embodiment, when receiving a switch input (e.g., a pressure input by the user to an automatic switch corresponding to the stand-up mode) corresponding to a request for an operation in the stand-up mode while the location state of the seat is maintained based on the general mode, the seat control apparatus may control the seat to the location state according to reference numeral 225. For example, the seat control apparatus may move (or fold) the backrest 255 to a front side by adjusting an angle of the backrest 254 of the seat and move the cushion 264 to an upper side to implement the stand-up operation mode of moving the seat uprights. Through the control of the seat location control, the user may move to the rear seat of the seat illustrated in FIG. 2E conveniently and promptly.

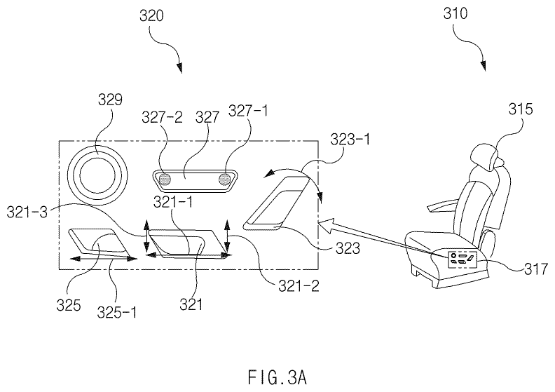

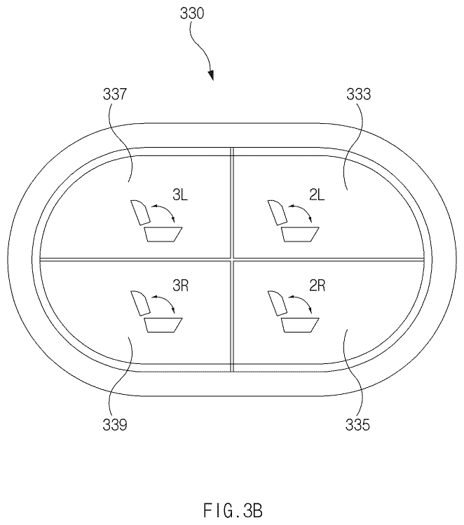

FIGS. 3A and 3B may be views illustrating implementations of an input part (e.g., the input part 110 of FIG. 1) included in the seat control apparatus (e.g., the seat control apparatus 100 of FIG. 1).

FIG. 3A is a conceptual view illustrating the input part of the seat control apparatus according to an embodiment of the present disclosure.

Referring to reference numeral 310, according to an embodiment, the seat control apparatus may include an input part that is disposed in one area 317 of a seat 315. The one area 317 of the seat 315 may be a portion of a side area of the seat, but this is exemplary and the embodiments of the present disclosure are not limited thereto.

Referring to reference numeral 320, according to an embodiment, the input part may include a plurality of switches corresponding to a plurality of types.

For example, the input part may include a first switch 321 that controls at least one of a slide location of the seat 315, a location of the cushion, a tilting angle of the cushion, or any combination thereof. As an example, the first switch 321 may be a manual switch. In other words, according to an input type (or input direction) of a user input to the first switch 321, the seat control apparatus may perform a control of a seat location. Furthermore, because the first switch 321 is a manual switch, a location control corresponding to the corresponding user input may be consistently perform in corresponding to the user input to the first switch 321, and thus the location control may be stopped when the user input is stopped.

As an example, when receiving a user input of a first direction 321-1 to the first switch 321, the seat control apparatus may adjust the slide location of the seat 315 to the first direction 321-1 (e.g., a forward direction or a rearward direction).

As an example, when a user input of a second direction 321-2 to the first switch 321, the seat control apparatus may adjust the cushion location of the seat 315 to the second direction 321-2 (e.g., an upward direction or a downward direction).

As an example, when receiving a user input of a third direction 321-3 to the first switch 321, the seat control apparatus may adjust the tilting angle of the cushion to the third direction 321-3 (e.g., an upward direction or a downward direction).

For example, the input part may include a second switch 323 that controls the reclining angle (or an angle of the backrest) of the seat 315. As an example, the second switch 323 may be a manual switch. In other words, according to the input type (or input direction) of a user input to the second switch 323, the seat control apparatus may perform a control of the location of the seat. Furthermore, the second switch 323 is a manual switch. Thus, the second switch 323 may consistently perform a location control corresponding to the corresponding user input in correspondence to the user input to the second switch 323. The second switch 323 may also stop the location control when the user input is stopped.

As an example, when receiving a user input of a fourth direction 323-1 to the second switch 323, the seat control apparatus may adjust the reclining angle of the seat to the fourth direction 323-1. In other words, the seat control apparatus may fold the reclining angle of the seat 315 toward a front side in a direction corresponding to the user input or may unfold the reclining angle toward a rear side.

For example, the input part may include a third switch 325 that controls a leg rest angle of the seat 315. As an example, the third switch 325 may be a manual switch. In other words, according to an input type (or input direction) of a user input to the third switch 325, the seat control apparatus may perform a control of the location of the seat. Furthermore, the third switch 325 is a manual switch. Thus, the third switch 325 may consistently perform a location control corresponding to the corresponding user input in correspondence to the user input to the second switch 323. The third switch 325 may also stop the location control when the user input is stopped.

As an example, when receiving a user input of a fifth direction 325-1 to the third switch 325, the seat control apparatus may adjust the reclining angle of the seat 315 to a direction corresponding to the fifth direction 325-1. For example, when receiving a user input for pushing the third switch 325 to a left side, the seat control apparatus may adjust an angle of a leg rest of the seat 315 such that an end of the leg rest is moved toward a ceiling of the host vehicle. As another example, when receiving a user input for pushing the third switch 325 to a right side, the seat control apparatus may adjust the angle of the leg rest of the seat 315 such that the end of the leg rest is moved toward a bottom of the host vehicle.

For example, the input part may include a fourth switch 327 that controls the operation mode of the seat 315 to a relaxation mode. As an example, the fourth switch 327 may be an automatic switch. In other words, when receiving a user input (e.g., a pressure input to one area of the fourth switch 327) to the fourth switch 327, the seat control apparatus may identify a corresponding function corresponding to a switch by which the corresponding user input is received. The seat control apparatus may also perform a control of the location of the seat to the operation mode corresponding to the corresponding function. Furthermore, the fourth switch 327 is an automatic switch. Thus, the fourth switch 327 may consistently perform a control of the location corresponding to the corresponding user input in correspondence to the user input to the fourth switch 327. The fourth switch 327 may also continuously perform the control of the location of the seat to the operation mode corresponding to the user input even though the user input is stopped.

As an example, when receiving a user input to a first area 327-1 of the fourth switch 327, the seat control apparatus may automatically control the seat 315 to the relaxation mode. In other words, only with a one touch input to the first area 327-1, the seat control apparatus may automatically control the seat 315 such that the seat 315 corresponds to the relaxation mode.

As an example, when receiving a user input to a second area 327-2 of the fourth switch 327, the seat control apparatus may automatically control the seat 315 to an original state (e.g., the general mode according to reference numeral 211 of FIG. 2A) in the relaxation mode. In other words, only with a one touch input to the second area 327-2, the seat control apparatus may automatically control the seat 315 such that the seat 315 corresponds to the general mode.

For example, the input part may include a fifth switch 329 that controls the operation mode of the seat 315 to at least one of various operation modes (e.g., a tip and slide mode, a walk-in mode, an easy entry mode, a slide and go mode, a backrest folding mode, a double folding mode, a stand-up mode, and a dive and go mode) included in the first control function. As an example, the fifth switch 329 may be an automatic switch. In other words, when receiving a user input (e.g., a pressure input to one area of the fifth switch 329) to the fifth switch 329, the seat control apparatus may identify a corresponding function corresponding to a switch by which the corresponding user input is received. The seat control apparatus may also perform a control of the location of the seat to the operation mode corresponding to the corresponding function. Furthermore, the fifth switch 329 is an automatic switch. Thus, the fifth switch 329 may consistently perform a control of the location corresponding to the corresponding user input in correspondence to the user input to the fifth switch 329. The fifth switch 329 may also continuously perform the control of the location of the seat to the operation mode corresponding to the user input even though the user input is stopped.

As an example, when receiving a user input to at least a portion of the fifth switch 329, the seat control apparatus may automatically control the seat 315 to the specific target state based on a corresponding function corresponding to the fifth switch 329. In other words, only with a one touch input to the fifth switch 329, the seat control apparatus may automatically control the seat 315 to the specific target state.

As an example, when receiving a user input to at least a portion of the fifth switch 329 in a situation in which the seat 315 is operated in the specific target state, the seat control apparatus may automatically control the seat 315 to the general mode in the specific target state. In other words, only with a one touch input to the fifth switch 329, the seat control apparatus may automatically restore the seat 315 from the specific target state to the general mode.

FIG. 3B is a conceptual view illustrating the input part of the seat control apparatus according to an embodiment of the present disclosure.

Referring to reference numeral 330, according to an embodiment, the seat control apparatus may include an input part that is disposed in remaining areas (e.g., one area of a luggage trim of a seat of row 3), except for the one are 317 of the seat 315.

For example, the input part may include at least one switch 333, 335, 337, or 339 that allows the seat control apparatus to adjust angles of backrests of, among the plurality of seats in the host vehicle, left and right seats of row 2 and left and right seats of row 3.

As an example, the at least one switch 333, 335, 337, and 339 may be an automatic switch.

In other words, when receiving a user input to the at least one switch 333, 335, 337, or 339, the seat control apparatus may identify a corresponding function corresponding to a switch by which the corresponding user input is received. The seat control apparatus may also perform a control of the location of the seat to an operation mode corresponding to the corresponding function.

Furthermore, the at least one switch 333, 335, 337, or 339 is an automatic switch. Thus, the at least one switch 333, 335, 337, or 339 may consistently perform a control of the location corresponding to the corresponding user input in correspondence to the user input to the at least one switch 333, 335, 337, or 339. The at least one switch 333, 335, 337, or 339 may also continuously perform the control of the location of the seat to the operation mode corresponding to the user input even though the user input is stopped.

As an example, the first folding switch 333 may be an input device that allows the seat control apparatus to adjust an angle of the backrest of a left seat of row 2 to a front side such that the backrest is folded, based on the received user input.

As an example, the second folding switch 335 may be an input device that allows the seat control apparatus to adjust an angle of the backrest of a right seat of row 2 to a front side such that the backrest is folded, based on the received user input.

As an example, the third folding switch 337 may be an input device that allows the seat control apparatus to adjust an angle of the backrest of a left seat of row 3 to a front side such that the backrest is folded, based on the received user input.

As an example, the fourth folding switch 339 may be an input device that allows the seat control apparatus to adjust an angle of the backrest of a right seat of row 3 to a front side such that the backrest is folded, based on the received user input.

As an example, when the angle of the backrest of the specific seat based on the user input to the at least one switch 333, 335, 337, or 339 is adjusted and then when the user input to the at least one switch 333, 335, 337, or 339 corresponding to the specific seat is received, the seat control apparatus may automatically restore the angle of the backrest of the specific seat.

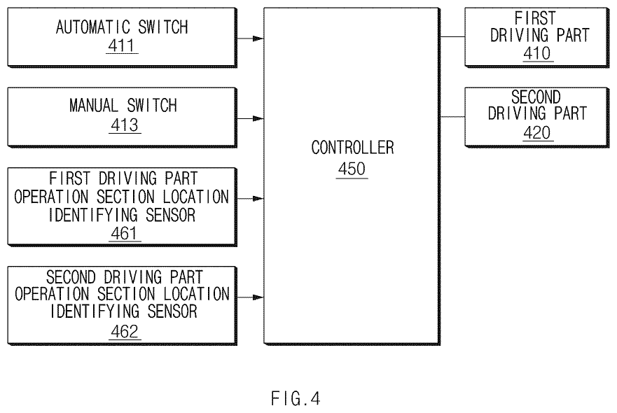

FIG. 4 is a block diagram illustrating components of the seat control apparatus according to an embodiment of the present disclosure.

According to an embodiment, the seat control apparatus (e.g., the seat control apparatus 100 of FIG. 1) may include at least one of an automatic switch 411, a manual switch 413, a first driving part operation section location identifying sensor 461, a second driving part operation section location identifying sensor 462, a controller 450, a first driving part 410, a second driving part 420, or any combination thereof.

For example, the seat control apparatus may receive a switch input for controlling a location of a seat from the automatic switch 411 and/or the manual switch 413. A description of the automatic switch 411 and the manual switch 413 may be replaced by the above description of FIGS. 3A and 3B.

For example, when receiving a switch input, the seat control apparatus may identify a current slide location and a current reclining angle of the seat. As an example, the seat control apparatus may identify a slide location of the seat by the first driving part 410 and a reclining angle of the seat by the second driving part 420.

As an example, the seat control apparatus may identify the slide location and the reclining angle of the seat based on operation states of the first driving part 410 and the second driving part 420.

As an example, the seat control apparatus may identify in which one of a first location section and a second location section disposed at a rear location section of the first location section the slide location of the seat is included, by using the first driving part operation section location identifying sensor 461.

As an example, the seat control apparatus may identify in which of a first angle section and a second angle section disposed at a rear angle section of the first angle section the reclining angle of the seat is included, by using the second driving part operation section location identifying sensor 462.

For example, the seat control apparatus may identify a specific target state based on at least one of a type (e.g., the automatic switch 411 or the manual switch 413) of a switch corresponding to the switch input, a corresponding function, a location section including a slide location, an angle section including a reclining angle, or any combination thereof.

For example, the seat control apparatus may control the location of the seat such that the location of the seat corresponds to a specific target state by using at least one of the first driving part 410, the second driving part 420, or any combination thereof.

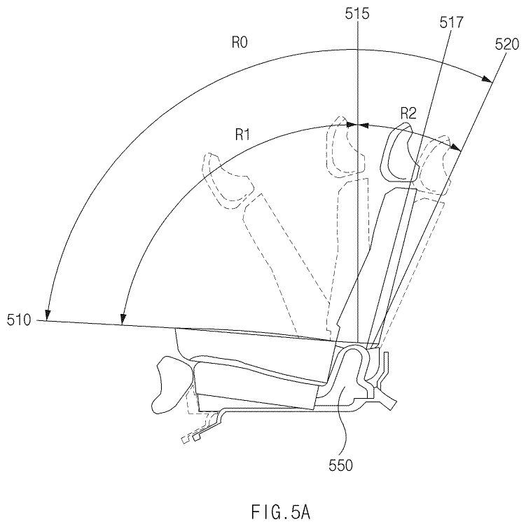

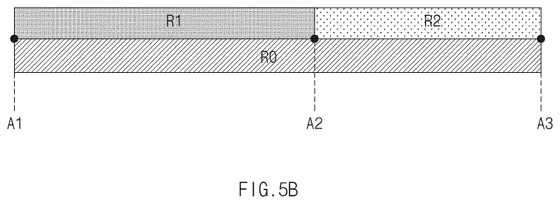

FIG. 5A is a conceptual view illustrating a classification of the angle section including the reclining angle of the seat according to an embodiment of the present disclosure.

According to an embodiment, the seat control apparatus (e.g., the seat control apparatus 100 of FIG. 1) may identify to which angle section the reclining angle of a seat 550 corresponds.

For example, the seat control apparatus may identify an entire angle section R0 in which the reclining angle may be adjusted, when the entire angle section R0 is divided into a first angle section R1 and a second angle section R2.

As an example, the seat control apparatus may control the reclining angle of the seat 550 in a range of a foremost angle point 510 to a rearmost angle point 520.

As an example, when one area (e.g., a headrest) of the seat 550 is located in the first angle section R1, it may be defined that the reclining angle is included in the first angle section R1.

As an example, when one area of the seat 550 is located in the second angle section R2, it may be defined that the reclining angle is included in the second angle section R2.

As an example, a first angle point 515 may be one point at which the first angle section R1 and the second angle section R2 are divided.

As an example, a second angle point 517 may be a point at which the reclining angle of the seat 550 corresponds to a reclining angle corresponding to a specific operation mode (e.g., a general (restoring) mode or a producer setting mode). In other words, when receiving a user input that requests for a control to the specific operation mode, the seat control apparatus may adjust the reclining angle of the seat 550 to an angle corresponding to the second angle point 517.

FIG. 5B is a conceptual view illustrating a classification of the angle section in which the reclining angle of the seat is included according to an embodiment of the present disclosure.

According to an embodiment, the seat control apparatus may adjust the reclining angle of the seat 550 to one of the entire angle section R0 from the foremost angle point 510 to the rearmost angle point 520.

For example, at the foremost angle point 510, the reclining angle of the seat 550 may be defined as A1 (e.g., 100 degrees).

For example, at the first angle point 515, the reclining angle of the seat 550 may be defined as A2 (e.g., 40 degrees).

For example, at the rearmost angle point 520, the reclining angle of the seat 550 may be defined as A3 (e.g., 0 degrees).

For example, when the reclining angle of the seat 550 is A1 to A2, it may be identified that the reclining angle of the seat 550 is included in the first angle section R1.

For example, when the reclining angle of the seat 550 is A2 to A3, it may be identified that the reclining angle of the seat 550 is included in the second angle section A2.

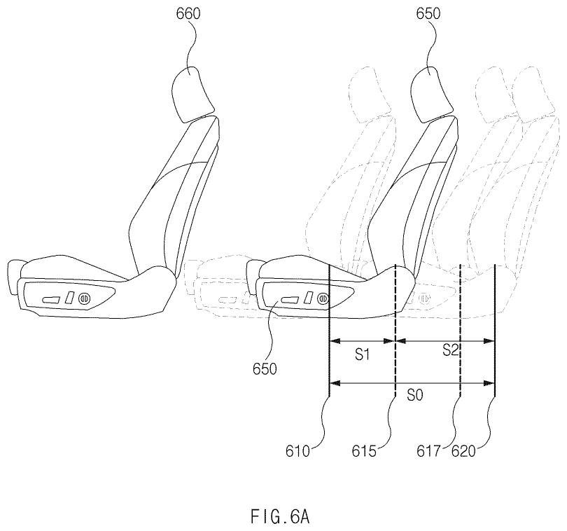

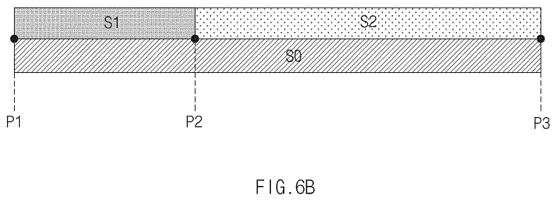

FIG. 6A is a conceptual view illustrating a classification of a location section in which a slide location of the seat is included, according to an embodiment of the present disclosure.

According to an embodiment, the seat control apparatus (e.g., the seat control apparatus 100 of FIG. 1) may identify to which location section a slide location of a seat 650 corresponds.

For example, the seat control apparatus may identify an entire location section S0 in which the slide location may be adjusted, when the entire location section S0 is divided into a first location section S1 and a second location section S2.

As an example, the seat control apparatus may control the slide location of the seat in a range of a foremost location point 610 to a rearmost location point 620. At the foremost location point 610, an end of a cushion of the seat 650 may be closest to a front seat 660.

As an example, when one area (e.g., one area to which the cushion and the backrest are connected) of the seat 650 is located in the first location section S1, it may be defined that the slide location is included in the first location section S1.

As an example, when one area of the seat 650 is located in the second location section S2, it may be defined that the slide location is included in the second location section S2.

As an example, a first location point 615 may be one point at which the first location section S1 and the second location section S2 are divided.

As an example, a second location point 617 may be a point at which the slide location of the seat 650 corresponds to a slide location corresponding to a specific operation mode (e.g., a general (restoring) mode or a producer setting mode). In other words, when receiving a user input that requests for a control to the specific operation mode, the seat control apparatus may adjust the reclining angle of the seat 650 to an angle corresponding to the second location point 617.

FIG. 6B is a conceptual view illustrating a classification of a location section in which a slide location of the seat is included, according to an embodiment of the present disclosure.

According to an embodiment, the seat control apparatus may adjust the slide location of the seat 650 to one of the entire location section S0 from the foremost location point 610 to the rearmost location point 620.

For example, at the foremost location point 610, a location parameter corresponding to the slide location of the seat 650 may be defined as P1 (e.g., 210).

For example, at the first location point 615, a location parameter corresponding to the slide location of the seat 650 may be defined as P2 (e.g., 165).

For example, at the rearmost location point 620, a location parameter corresponding to the slide location of the seat 650 may be defined as P3 (e.g., 0).

For example, when a location parameter corresponding to the slide location of the seat 650 is P1 to P2, it may be identified that the slide location of the seat 650 is included in the first location section S1.

For example, when a location parameter corresponding to the slide location of the seat 650 is P2 to P3, it may be identified that the slide location of the seat 650 is included in the second location section S2.

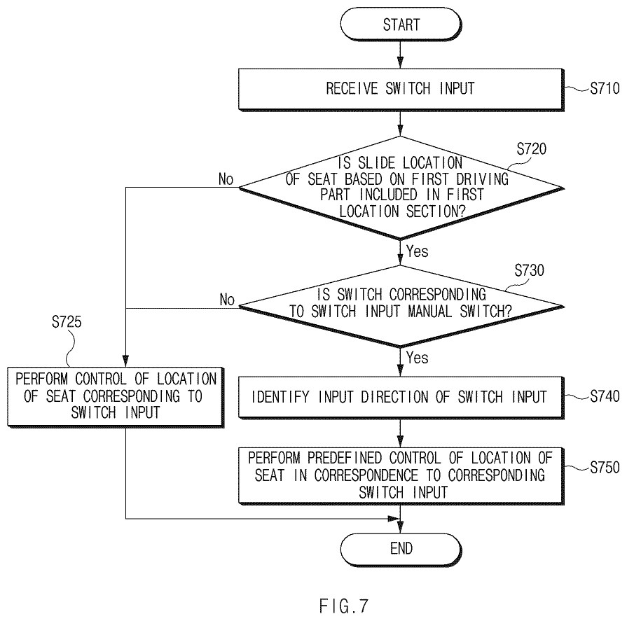

FIG. 7 is a flowchart of a seat control method according to an embodiment of the present disclosure.

According to an embodiment, the seat control apparatus (e.g., the seat control apparatus 100 of FIG. 1) may perform operations disclosed in FIG. 7. For example, at least some of the components (e.g., the input part 110, the first driving part 120, the second driving part 130, the memory 140, the controller 150, and the sensor part 160 of FIG. 1) included in the seat control apparatus may be configured to perform the operations of FIG. 7.

Hereinafter, in the embodiments, operations of S710 to S750 may be sequentially performed, but are not necessarily sequentially performed. For example, the sequence of the operations may be changed, and at least two operations may be performed in parallel. Furthermore, contents corresponding to the contents described above in relation to FIG. 7 or repeated contents may be briefly described or omitted.

According to an embodiment, the seat control apparatus may receive a switch input (S710).

For example, the seat control apparatus may receive and identify a pressure input by the user to at least one of the plurality of switches included in an input part.

According to an embodiment, the seat control apparatus may identify whether the slide location of the seat based on the first driving part is included in the first location section (S720).

For example, when the slide location of the seat is included in the first location section (e.g., operation S720—Yes), the seat control apparatus may perform operation S730.

For example, when the slide location of the seat is not included in the first location section (e.g., operation S720—No), the seat control apparatus may perform operation S725.

According to an embodiment, the seat control apparatus may identify whether a switch corresponding to the switch input corresponds to a manual switch (S730).

For example, when the switch corresponding to the switch input corresponds to a manual switch (e.g., operation S730—Yes), the seat control apparatus may perform operation S740.

For example, when the switch corresponding to the switch input does not correspond to a manual switch (e.g., operation S730—No), the seat control apparatus may perform operation S725.

According to an embodiment, the seat control apparatus may perform a control the location of the seat corresponding to the switch input (S725).

For example, when the switch corresponding to the switch input is a manual switch, the seat control apparatus may perform functions (e.g., the functions of the manual switch according to FIG. 3A) originally corresponding to the manual switch.

For example, when the switch corresponding to the switch input is an automatic switch, the seat control apparatus may perform functions (e.g., the functions of the automatic switch according to FIG. 3A) originally corresponding to the automatic switch.

According to an embodiment, the seat control apparatus may identify an input direction of the switch input (S740).

For example, the seat control apparatus may identify an input type including at least one of an input direction, an input angle, or an input intensity of the switch input, or any combination thereof.

According to an embodiment, the seat control apparatus may perform a predefined control of the location of the seat in correspondence to the corresponding switch input (S750).

For example, the seat control apparatus may identify a predefined automatic control function that is configured in correspondence to at least one of a type of the switch corresponding to the switch input, an input type of the switch input, or any combination thereof.

For example, the predefined automatic control function may include a control function of controlling the location of the seat to at least one of a non-operation mode (or a switch input neglected mode), an elevation mode, a folding mode, a restoring mode, a foremost mode, a rearmost mode, a producer setting mode, a user storing mode, or any combination thereof.

For example, the seat control apparatus may perform the identified automatic control function. In other words, even when the switch corresponding to the switch input is a manual switch, the seat control apparatus may perform a predefined automatic control function based on the above-described operation.

Furthermore, although the illustration of FIG. 7 is limited to a case in which the slide location is the first location section, the embodiments of the present disclosure are not limited thereto. For example, in operation S720, even when the reclining angle of the seat based on the second driving part is included in the first angle section, the seat control apparatus may perform substantially the same operations as operations S730 to S750.

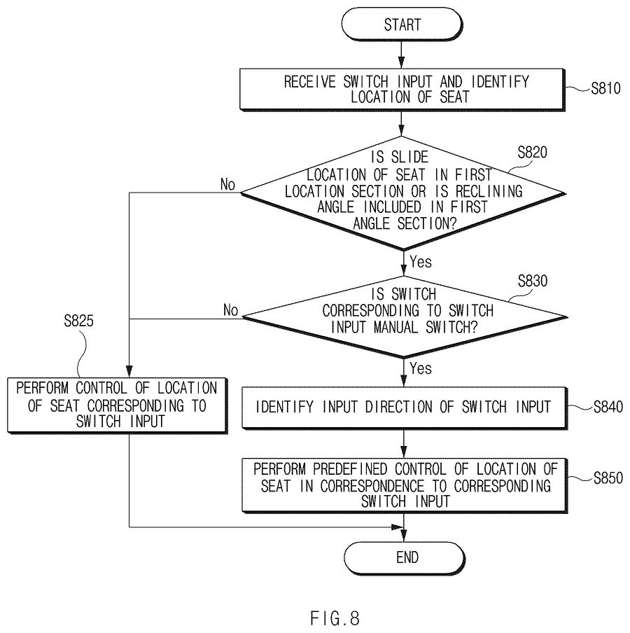

FIG. 8 is a flowchart of a seat control method according to an embodiment of the present disclosure.

According to an embodiment, the seat control apparatus (e.g., the seat control apparatus 100 of FIG. 1) may perform the operations disclosed in FIG. 8. For example, at least some of the components (e.g., the input part 110, the first driving part 120, the second driving part 130, the memory 140, the controller 150, and the sensor part 160 of FIG. 1) included in the seat control apparatus may be configured to perform the operations of FIG. 8.

Hereinafter, in the embodiments, operations of S810 to S850 may be sequentially performed but are not necessarily sequentially performed. For example, the sequence of the operations may be changed, and at least two operations may be performed in parallel. Furthermore, contents corresponding to the contents described above in relation to FIG. 8 or repeated contents may be briefly described or omitted.

According to an embodiment, the seat control apparatus may receive a switch input and may identify a location (or a current operation state of the seat) of the seat (S810).

For example, the seat control apparatus may identify a section in which the reclining angle and the slide location of the seat are included, by using the sensor part and/or based on the operation states of the driving parts.

According to an embodiment, the seat control apparatus may identify whether the slide location of the seat is included in the first location section or the reclining angle is included in the first angle section (S820).

For example, when the slide location of the seat is included in the first location section or the reclining angle is included in the first angle section (e.g., operation S820—Yes), the seat control apparatus may perform operation S830.

For example, when the slide location of the seat is included in the second location section and the reclining angle is included in the second angle section (e.g., operation S820—No), the seat control apparatus may perform operation S825.

According to an embodiment, the seat control apparatus may identify whether the switch corresponding to the switch input is a manual switch (S830).

For example, when the switch corresponding to the switch input corresponds to a manual switch (e.g., operation S830—Yes), the seat control apparatus may perform operation S840.

For example, when the switch corresponding to the switch input does not correspond to a manual switch (e.g., operation S830—No), the seat control apparatus may perform operation S825.

According to an embodiment, the seat control apparatus may perform a control of the location of the seat corresponding to the switch input (S825).

For example, when the switch corresponding to the switch input is a manual switch, the seat control apparatus may perform functions (e.g., the functions of the manual switches according to FIG. 3A) originally corresponding to the manual switch.

For example, when the switch corresponding to the switch input is an automatic switch, the seat control apparatus may perform functions (e.g., the functions of the automatic switches according to FIG. 3A) originally corresponding to the automatic switch.

According to an embodiment, the seat control apparatus may identify an input direction of the switch input (S840).

For example, the seat control apparatus may identify an input type including at least one of an input direction, an input angle, or an input intensity of the switch input, or any combination thereof.

According to an embodiment, the seat control apparatus may perform a predefined control of the location of the seat in correspondence to the corresponding switch input (S850).

For example, the seat control apparatus may identify a predefined automatic control function that is configured in correspondence to at least one of a type of the switch corresponding to the switch input, an input type of the switch input, or any combination thereof.

For example, the predefined automatic control function, for example, may include a control function of controlling the location of the seat to at least one of a non-operation mode (or a switch input neglected mode), an elevation mode, a folding mode, a restoring mode, a foremost mode, a rearmost mode, a producer setting mode, a user storing mode, or any combination thereof to control the location of the seat.

For example, the seat control apparatus may perform the identified automatic control function. In other words, even when the switch corresponding to the switch input is a manual switch, the seat control apparatus may perform a predefined automatic control function based on the above-described operation.

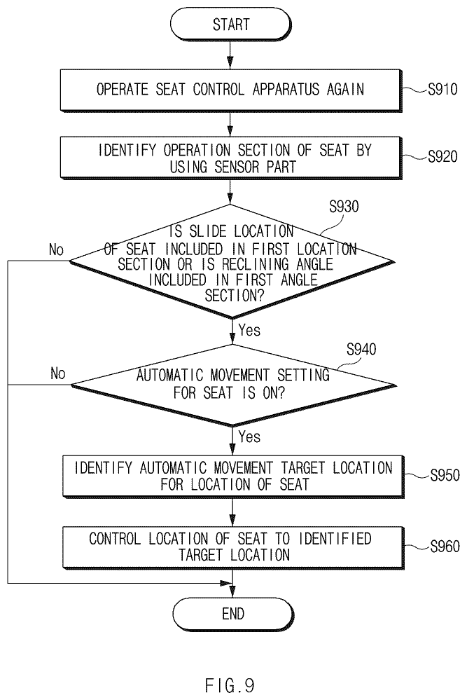

FIG. 9 is a flowchart of a seat control method according to an embodiment of the present disclosure.

According to an embodiment, the seat control apparatus (e.g., the seat control apparatus 100 of FIG. 1) may perform operations disclosed in FIG. 9. For example, at least some of the components (e.g., the input part 110, the first driving part 120, the second driving part 130, the memory 140, the controller 150, and the sensor part 160 of FIG. 1) included in the seat control apparatus may be configured to perform the operations of FIG. 9.

Hereinafter, in the embodiments, operations of S910 to S960 may be sequentially performed but are not necessarily sequentially performed. For example, the sequence of the operations may be changed, and at least two operations may be performed in parallel. Furthermore, contents corresponding to the contents described above in relation to FIG. 9 or repeated contents may be briefly described or omitted.

According to an embodiment, the seat control apparatus may identify a situation in which the seat control apparatus is operated again (S910).

For example, not only in a situation in which the seat control apparatus is operated again but also in a situation in which the host vehicle is restarted or a door corresponding to the seat is opened in a state in which no passenger is seated on the seat, the seat control apparatus may perform operation S920 below.

According to an embodiment, the seat control apparatus may identify an operation section of the seat by using the sensor part (S920).

For example, the seat control apparatus may identify the operation section of the seat based on an operation state of the driving part.

According to an embodiment, the seat control apparatus may identify whether the slide location of the seat is included in the first location section or the reclining angle is included in the first angle section (S930).

For example, when the slide location of the seat is included in the first location section or the reclining angle is included in the first angle section (e.g., operation S930—Yes), the seat control apparatus may perform operation S940.

For example, when the slide location of the seat is included in the second location section and the reclining angle is included in the second angle section (e.g., operation S930—No), the seat control apparatus may end the operation.

According to an embodiment, the seat control apparatus may identify whether the automatic movement setting for the seat is in an on state (S940).

For example, the seat control apparatus may identify whether the automatic movement setting for automatically controlling the control of the location of the seat to a target location in a situation in which the seat control apparatus is operated again, the host vehicle is restarted, or a door corresponding to the seat is opened in a state in which no passenger is seated on the seat is in an on state.

For example, when the automatic movement setting for the seat is in the on state (e.g., operation S940—Yes), the seat control apparatus may perform S950.

For example, when the automatic movement setting for the seat is in an off state (e.g., operation S940—No), the seat control apparatus may end the operation.

According to an embodiment, the seat control apparatus may identify automatic movement target locations for the locations of the seat (S950).

For example, the seat control apparatus may identify a current location of the seat in a situation in which the seat control apparatus is operated again, the host vehicle is restarted, or a door corresponding to the seat is opened in a state in which no passenger is seated on the seat. The seat control apparatus may also identify the set automatic movement target location in correspondence to the identified location.

According to an embodiment, the seat control apparatus may perform a control of the location of the seat to the identified target location to control the driving part such that the seat is moved to the target location (S960).

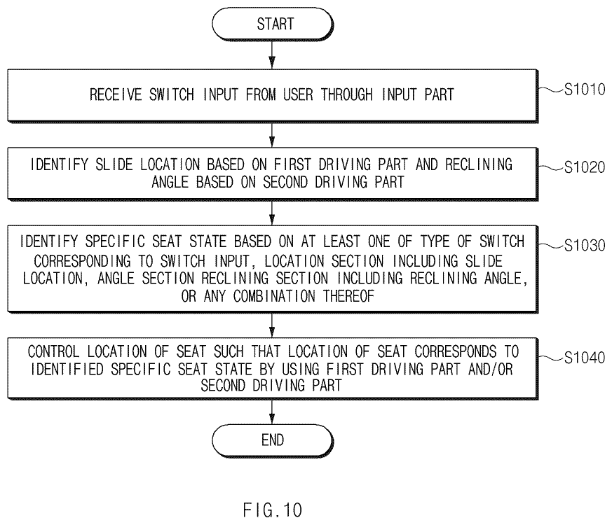

FIG. 10 is a flowchart of a seat control method according to an embodiment of the present disclosure.

According to an embodiment, the seat control apparatus (e.g., the seat control apparatus 100 of FIG. 1) may perform operations disclosed in FIG. 10. For example, at least some of the components (e.g., the input part 110, the first driving part 120, the second driving part 130, the memory 140, the controller 150, and the sensor part 160 of FIG. 1) included in the seat control apparatus may be configured to perform the operations of FIG. 10.

Hereinafter, in the embodiments, operations of S1010 to S1040 may be sequentially performed but are not necessarily sequentially performed. For example, the sequence of the operations may be changed, and at least two operations may be performed in parallel. Furthermore, contents corresponding to the contents described above in relation to FIG. 10 or repeated contents may be briefly described or omitted.

According to an embodiment, the seat control apparatus may receive a switch input from the user through the input part (S1010).

According to an embodiment, the seat control apparatus may identify a slide location of the seat based on the first driving part and a reclining angle of the seat based on the second driving part (S1020).

According to an embodiment, the seat control apparatus may identify a specific seat state based on at least one of a type of the switch corresponding to a switch input, a location section including the slide location, an angle section including the reclining angle, or any combination thereof (S1030).

According to an embodiment, the seat control apparatus may perform a control of the location of the seat such that the location of the seat corresponds to the identified specific seat state by using at least one of the first driving part, the second driving part, or any combination thereof (S1040).

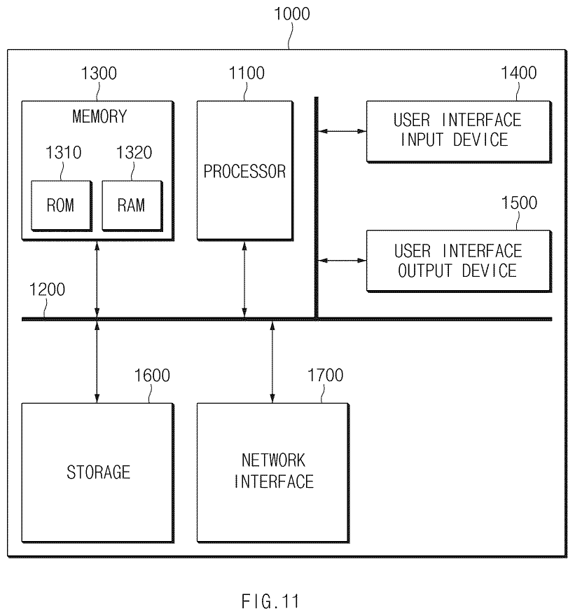

FIG. 11 illustrates a computing system regarding a seat control method according to an embodiment of the present disclosure.

Referring to FIG. 11, a computing system 1000 for the seat control method may include at least one processor 1100, a memory 1300, a user interface input device 1400, a user interface output device 1500, a storage 1600, and a network interface 1700, which are connected through a bus 1200.

The processor 1100 may be a central processing unit (CPU), or a semiconductor device that processes instructions stored in the memory 1300 and/or the storage 1600. The memory 1300 and the storage 1600 may include various volatile or nonvolatile storage media. For example, the memory 1300 may include a read only memory 1310 (ROM) and a random access memory 1320 (RAM).

Accordingly, the steps of the method or algorithm described in relation to the embodiments of the present disclosure may be implemented directly by hardware executed by the processor 1100, a software module, or a combination thereof. The software module may reside in a storage medium (i.e., the memory 1300 and/or the storage 1600), such as a RAM, a flash memory, a ROM, an EPROM, an EEPROM, a register, a hard disk, a solid state drive (SSD), a detachable disk, or a CD-ROM.

The storage medium is coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

Effects of the seat control apparatus and the seat control method according to the present disclosure are described below.

According to at least one of the embodiments of the present disclosure, the seat control apparatus, when receiving a user input through an input part, may identify a current location state of a seat, which includes a slide location of the seat by a first driving part and a reclining angle of the seat by a second driving part, and may classify the identified current location state for sections to perform different seat controls for the sections.

According to at least one of the embodiments of the present disclosure, the seat control apparatus may identify a specific target state based on at least one of a type of a switch corresponding to a switch input, a corresponding function, a location section including a slide location, an angle section including a reclining angle, or any combination thereof. The seat control apparatus may also control a location of a seat such that the location of the seat corresponds to the specific target state by using at least one of a first driving part, a second driving part, or any combination thereof.

According to at least one of the embodiments of the present disclosure, the seat control apparatus may include at least one automatic switch corresponding to a first control function of controlling an operation state of a seat to at least one of a tip and slide mode, a walk-in mode, an easy entry mode, a slide and go mode, a backrest folding mode, a double folding mode, a stand-up mode, a dive and go mode, a relaxation mode, or any combination thereof. Alternatively, the first control function includes restoring the operation state of the seat to an original state. The seat control apparatus may also include at least one manual switch corresponding to a second control function of adjusting at least one of a slide location, a cushion height, a tilting angle, a backrest angle, a leg rest angle, or any combination thereof in correspondence to a specific input received from the user.

According to at least one of the embodiments of the present disclosure, the seat control apparatus may, when it is identified that the seat control apparatus is operated again or a host vehicle is restarted, or when the door corresponding to the seat is opened in a state in which no passenger is seated on the seat, identify the slide location of the seat and the reclining angle of the seat. The seat control apparatus may also, when the slide location is included in the first angle section or the reclining angle is included in the first angle section, identify whether an automatic movement setting for the seat is an on state. The seat control apparatus may also, when the automatic movement setting is in an on state, control the seat to a defined target location based on the automatic movement setting.

According to at least one of the embodiments of the present disclosure, the seat control apparatus may identify in which of a first location section and a second location section disposed at a rear location section of the first location section a slide location of a seat is included, by using the sensor part. The seat control apparatus may also identify in which of a first angle section and a second angle section disposed at a rear angle section of the first angle section a reclining angle of the seat is included.

In addition, various effects directly or indirectly recognized through the specification may be provided.

The above description is a description of the technical spirits of the present disclosure. A person having ordinary skill in the art to which the present disclosure pertains may make various corrections and modifications without departing from the essential features of the present disclosure.

Therefore, the embodiments disclosed in the present disclosure are not intended to limit the technical spirits of the present disclosure but are intended to describe them, and the scope of the technical spirits of the present disclosure are not limited by the embodiments. The protection range of the present disclosure should be construed by the following claims, and all the technical spirits within the equivalent ranges should be construed as being included in the scope of the present disclosure.

What is claimed is:

1. A seat control apparatus comprising:
an input part disposed in one area of a seat;
a first driving part configured to adjust a slide location of the seat;
a second driving part configured to adjust a reclining angle of the seat;
a memory configured to store one or more instructions; and
a controller operatively connected to the input part, the first driving part, the second driving part, and the memory,
wherein the instructions, when being executed by the controller, cause the seat control apparatus to
receive a switch input from a user, through the input part,
identify the slide location of the seat by the first driving part and a reclining angle of the seat by the second driving part,
identify a specific target state based on at least one of a type of a switch corresponding to the switch input, a corresponding function, a location section including the slide location, an angle section including the reclining angle, or any combination thereof, and
control a location of the seat such that the location of the seat corresponds to the specific target state by using at least one of the first driving part, the second driving part, or any combination thereof.

2. The seat control apparatus of claim 1, wherein types of the switch include:
at least one automatic switch corresponding to a first control function of controlling an operation state of the seat to at least one of a tip and slide mode, a walk-in mode, an easy entry mode, a slide and go mode, a backrest folding mode, a double folding mode, a stand-up mode, a dive and go mode, a relaxation mode, or any combination thereof, or the at least one automatic switch corresponding to the first control function of restoring the operation state of the seat to an original state; and
at least one manual switch corresponding to a second control function of adjusting at least one of a slide location, a cushion height, a tilting angle, a backrest angle, a leg rest angle, or any combination thereof in correspondence to a specific input received from the user.

3. The seat control apparatus of claim 2 wherein the instructions, when being executed by the controller, cause to the seat control apparatus to:
identify the specific target state based on a corresponding function of the first control function, wherein the first control function corresponds to the at least one automatic switch when the switch input is received through a corresponding automatic switch; and
control a location of the seat based on the identified specific target state.

4. The seat control apparatus of claim 2, wherein the instructions, when being executed by the controller, cause to the seat control apparatus to:
identify a type of the switch corresponding to the switch input when the slide location is included in a first location section; and
perform a predefined automatic control function in correspondence to the switch input when the type of the switch corresponds to the at least one manual switch.

5. The seat control apparatus of claim 4, wherein the instructions, when being executed by the controller, cause to the seat control apparatus to:
identify the specific target state based on the corresponding function of the first control function and the second control function, wherein the second control function corresponds to an input type of the switch input and the at least one automatic switch when the slide location is included in a second location section disposed at a rear location section of the first location section, or when the slide location is included in the first location section and the type of the switch corresponds to the at least one automatic switch; and
control the location of the seat based on the identified specific target state.

6. The seat control apparatus of claim 2, wherein the instructions, when being executed by the controller, cause to the seat control apparatus to:
identify a type of the switch corresponding to the switch input when the reclining angle is included in a first angle section; and
perform a predefined automatic control function in correspondence to the switch input when the type of the switch corresponds to the at least one manual switch.

7. The seat control apparatus of claim 6, wherein the instructions, when being executed by the controller, cause to the seat control apparatus to:
identify the specific target state based on the corresponding function of the first control function and the second control function, wherein the second control function corresponds to an input type of the switch input and the at least one automatic switch when the reclining angle is included in a second angle section disposed at a rear angle section of the first angle section, or when the reclining angle is included in the first angle section and the type of the switch corresponds to the at least one automatic switch; and
control the location of the seat based on the identified specific target state.

8. The seat control apparatus of claim 2, wherein the instructions, when being executed by the controller, cause to the seat control apparatus to:
identify a type of the switch corresponding to the switch input when the slide location is included in a first location section or the reclining angle is included in a first angle section;
identify the specific target state based on the corresponding function of the first control function, wherein the first control function corresponds to the at least one automatic switch and control the location of the seat based on the identified specific target state when the type of the switch corresponds to the at least one automatic switch; and
perform a predefined automatic control function in correspondence to the switch input when the type of the switch corresponds to the at least one manual switch.

9. The seat control apparatus of claim 1, wherein the instructions, when being executed by the controller, cause to the seat control apparatus to:
identify the slide location of the seat and the reclining angle of the seat when it is identified that the seat control apparatus is operated again, a host vehicle is restarted, or no passenger is seated on the seat;
identify whether an automatic movement setting for the seat is an on state when the slide location is included in a first location section or the reclining angle is included in a first angle section; and
control the seat to a target location defined based on the automatic movement setting when the automatic movement setting is in the on state.

10. The seat control apparatus of claim 1, further comprising a sensor part, wherein the instructions, when being executed by the controller, cause to the seat control apparatus to:
identify in which of a first location section and a second location section disposed at a rear location section of the first location section the slide location of the seat is included, by using the sensor part; and
identify in which of a first angle section and a second angle section disposed at a rear angle section of the first angle section the reclining angle of the seat is included, by using the sensor part.

11. A seat control method comprising:
receiving, by a controller, a switch input from a user through an input part;
identifying, by the controller, a slide location of a seat by a first driving part and a reclining angle of the seat by a second driving part;
identifying, by the controller, a specific target state based on at least one of a type of a switch corresponding to the switch input, a corresponding function, a location section including a type of the slide location, an angle section including the reclining angle, or any combination thereof; and
controlling, by the controller, a location of the seat such that the location of the seat corresponds to the specific target state by using at least one of the first driving part, the second driving part, or any combination thereof.

12. The seat control method of claim 11, wherein types of the switch include:
at least one automatic switch corresponding to a first control function of controlling an operation state of the seat to at least one of a tip and slide mode, a walk-in mode, an easy entry mode, a slide and go mode, a backrest folding mode, a double folding mode, a stand-up mode, a dive and go mode, or a relaxation mode, or any combination thereof, or the at least one automatic switch corresponding to the first control function of restoring the operation state of the seat to an original state; and
at least one manual switch corresponding to a second control function of adjusting at least one of a slide location, a cushion height, a tilting angle, a backrest angle, a leg rest angle, or any combination thereof in correspondence to a specific input received from the user.

13. The seat control method of claim 11, wherein the receiving, by the controller, of the switch input from the user, through the input part includes:
identifying, by the controller, the specific target state based on a corresponding function of a first control function, wherein the first control function corresponds to at least one automatic switch when the switch input is received through a corresponding one automatic switch; and
controlling, by the controller, a location of the seat based on the identified specific target state.

14. The seat control method of claim 12, comprising:
identifying, by the controller, a type of the switch corresponding to the switch input when the slide location is included in a first location section; and
performing, by the controller, a predefined automatic control function in correspondence to the switch input when the type of the switch corresponds to the at least one manual switch.

15. The seat control method of claim 14, further comprising:
identifying, by the controller, the specific target state based on the corresponding function of the first control function and the second control function, wherein the second control function corresponds to an input type of the switch input and the at least one automatic switch when the slide location is included in a second location section disposed at a rear location section of the first location section, or when the slide location is included in the first location section and the type of the switch corresponds to the at least one automatic switch; and
controlling, by the controller, the location of the seat based on the identified specific target state.

16. The seat control method of claim 12, further comprising:
identifying, by the controller, a type of the switch corresponding to the switch input when the slide location is included in a first location section; and
performing, by the controller, a predefined automatic control function in correspondence to the switch input when the type of the switch corresponds to the at least one manual switch.

17. The seat control method of claim 16, further comprising:
identifying, by the controller, the specific target state based on the corresponding function of the first control function and the second control function, wherein the second control function corresponds to an input type of the switch input and the at least one automatic switch when the slide location is included in a second location section disposed at a rear location section of the first location section, or when the slide location is included in the first location section and the type of the switch corresponds to the at least one automatic switch; and
controlling, by the controller, the location of the seat based on the identified specific target state.

18. The seat control method of claim 12, further comprising:
identifying, by the controller, a type of the switch corresponding to the switch input when the slide location is included in a first location section or the reclining angle is included in a first angle section;
identifying, by the controller, the specific target state based on the corresponding function of the first control function, wherein the first control function corresponds to the at least one automatic switch and control the location of the seat based on the identified specific target state when the type of the switch corresponds to the at least one automatic switch; and
performing, by the controller, a predefined automatic control function in correspondence to the switch input when the type of the switch corresponds to the at least one manual switch.

19. The seat control method of claim 11, comprising:
identifying, by the controller, the slide location of the seat and the reclining angle of the seat when it is identified that a seat control apparatus is operated again or a host vehicle is restarted, or no passenger is seated on the seat;
identifying, by the controller, whether an automatic movement setting for the seat is an on state when the slide location is included in a first location section or the reclining angle is included in a first angle section; and
controlling, by the controller, the seat to a target location defined based on the automatic movement setting when the automatic movement setting is in the on state.

20. The seat control method of claim 11, further comprising:
identifying, by the controller, in which of a first location section and a second location section disposed at a rear location section of the first location section the slide location of the seat is included, by using a sensor part; and
identifying, by the controller, in which of a first angle section and a second angle section disposed at a rear angle section of the first angle section the reclining angle of the seat is included, by using the sensor part.
